(19) United States
(12) Patent Application Publication
(10) Pub. No.: US 2005/0286886 A1
(43) Pub. Date: Dec. 29, 2005

(54) Curtain holder

(76) Inventor: Zenon Koziak, Edmonton, CA (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/142,199

(22) Filed: Jun. 1, 2005

(30) Foreign Application Priority Data
Jun. 10, 2004 (CA) 2,472,632

(51) Int. Cl. G03B 17/24

(52) U.S. Cl. 396/318

(57) ABSTRACT

A curtain holder has a body formed from two pivotally connected segments and defining a curtain confining enclosure. Each of the segments has a connection end and a remote end. A mounting is provided for mounting the body to a vertical surface. A hinge pivotally connects the connection ends of the segments. The segments are pivotally movable between an open position in which the remote end of each of the segments are spaced apart to permit insertion of a curtain into the curtain confining enclosure and a closed position in which the remote end of the segments are closely spaced.

### FIELD OF THE INVENTION

The present invention relates to a curtain holder.

### BACKGROUND OF THE INVENTION

Curtain holders are used to hold shower curtains together.

### SUMMARY OF THE INVENTION

The present invention relates to a novel configuration of curtain holder.

According to the present invention there is provided a curtain holder, which has a body formed from at least two connected segments and defining a curtain confining enclosure. Each of the segments has a connection end and a remote end. Means are provided for mounting the body to a vertical surface. A hinge pivotally connects the connection ends of the segments. The segments are pivotally movable between an open position in which the remote end of each of the segments are spaced apart to permit insertion of a curtain into the curtain confining enclosure and a closed position in which the remote end of the segments are closely spaced.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a top plan view of the curtain holder in the closed position.

FIG. 2 is a top plan view of the curtain holder in the open position.

FIG. 3 is a side view of the curtain holder being used to hold back a curtain.

FIG. 4 is a detailed top view in partial section of interlocking components.

FIG. 5 is a side view of the curtain holder of FIG. 1 with an alternative hinge.

FIG. 6 in a detailed top plan view of alternative mounting means and another alternative hinge.

FIG. 7 is a detailed top plan views of another alternative hinge.

FIGS. 8 through 11 are detailed views of alternative interlocking components.

FIGS. 12 through 15 are top plan views of alternative body shapes.

FIG. 16 is a side perspective view of an alternative body shape.

FIGS. 17 and 18 are top plan views of further alternative body shapes.

FIG. 19 is a top plan view of a curtain holder mounted on a spring.

FIG. 20 is a top plan view in partial section of a rotatable curtain holder.

FIG. 21 is an end view in section of the curtain holder in FIG. 20 being rotated.

FIG. 22 is a top plan view of a curtain holder with a curtain clip.

### DETAILED DESCRIPTION OF THE PREFERRED EMBODIMENT

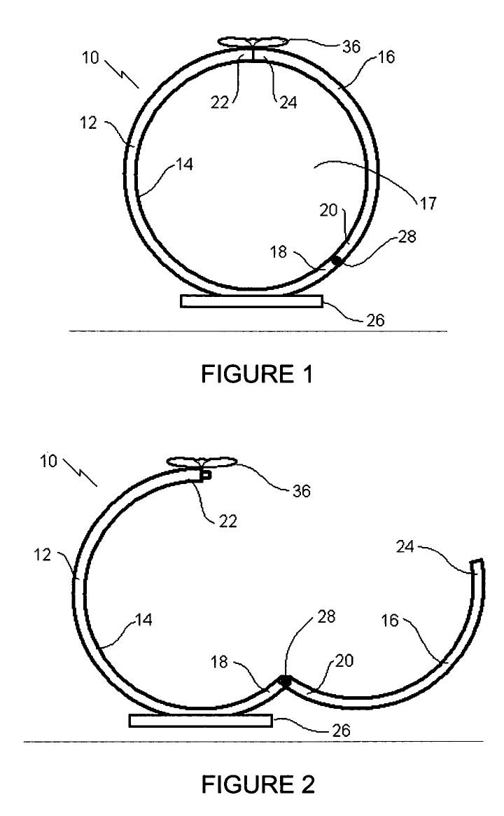

The preferred embodiment, a curtain holder generally identified by reference numeral 10, will now be described with reference to FIGS. 1 through 4 and 18.

Structure and Relationship of Parts:

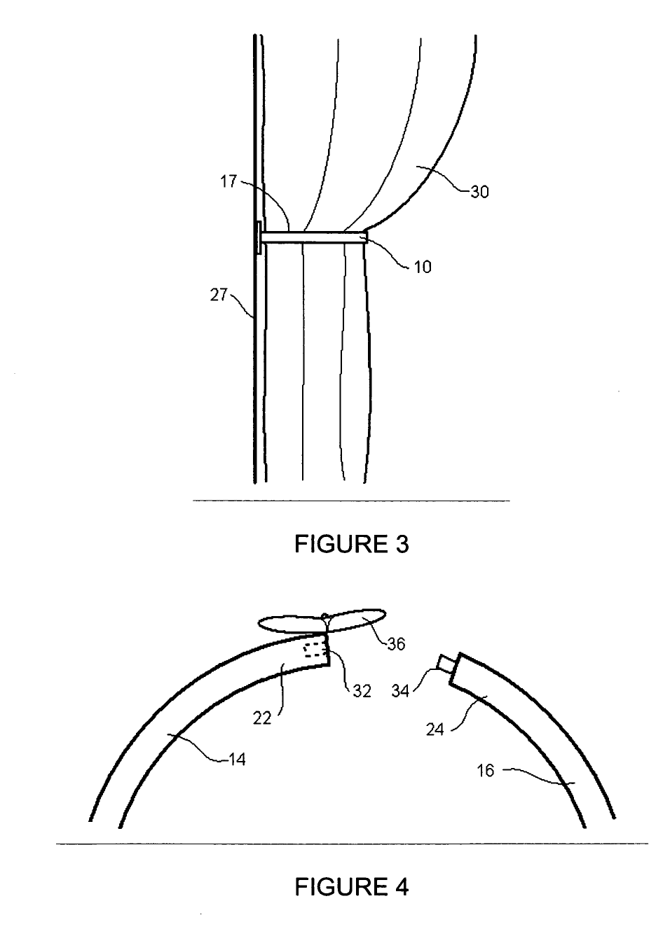

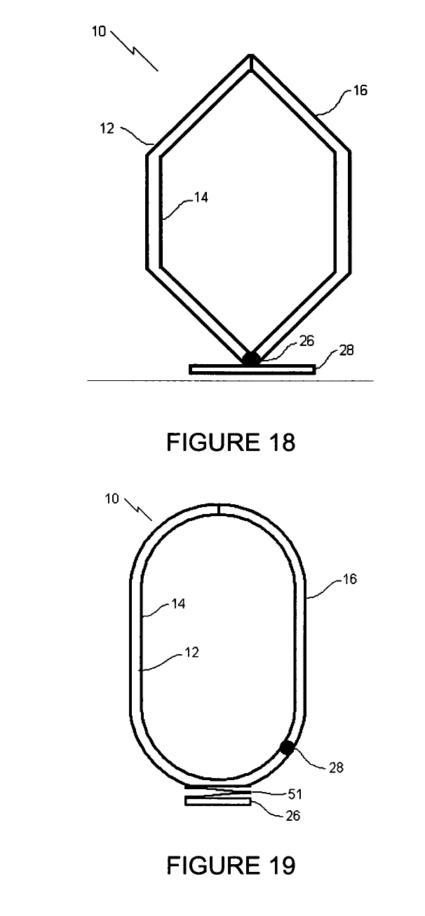

Referring now to FIG. 1, curtain holder 10 is shown. A generally annular body 12 is formed from two or more connected segments, 14 and 16 that define a curtain confining enclosure 17. Each segment 14 and 16 has a connection end 18 and 20 respectively, and a remote end 22 and 24 respectively. A mounting plate 26 provides means for mounting annular body 12 to a vertical surface 27, as shown in FIG. 3. Referring again to FIG. 1, a hinge 28 is offset from, and independent of, mounting plate 26. Referring to FIG. 18, hinge 28 may also be located in the center of mounting plate 26. Referring again to FIG. 1 hinge 28 pivotally connects connection ends 18 and 20 of segments 14 and 16, such that segments 14 and 16 are pivotally movable between an open position shown in FIG. 2 and a closed position shown in FIG. 1. Referring now to FIG. 2, in the open position, remote ends 22 and 24 are spaced apart to permit insertion of a curtain 30 into curtain confining enclosure 17, as shown in FIG. 3. Referring now to FIG. 1, in the closed position, remote ends 22 and 24 are closely spaced. As can be seen from the top view provided in FIGS. 1 and 2, hinge 28 pivots about a substantially vertical pivot axis. Because hinge 28 is offset from mounting plate 26, segments 14 and 16 are unequal in size to allow remote ends 22 and 24 to meet opposite mounting plate 26.

Referring to FIG. 4, remote ends 22 and 24 have first and second engagements 32 and 34 respectively, such that first engagement 32 and second engagement 34 matingly engage when segments 14 and 16 are in the closed position. Remote end 24 has a decorative member 36 which conceals first engagement 32 and second engagement 34 when segments 14 and 16 are in the closed position.

Operation:

The operation of curtain holder 10 will now be discussed with reference to FIGS. 1 through 4. Curtain holder 10 is mounted on a vertical surface 27 as shown in FIG. 3. Body 12 is originally in the closed position as shown in FIG. 1, with remote ends 22 and 24 engaged. Referring now to FIG. 2, segment 16 is pivoted about hinge 28 into the opened position. Referring now to FIG. 3, curtain 30 is placed within the opening created by pivoting segment 16 about hinge 28, and segment 16 is then returned to its original position such that remote ends 22 and 24 are engaged. Curtain 30 is removed by repeating the process.

Variations:

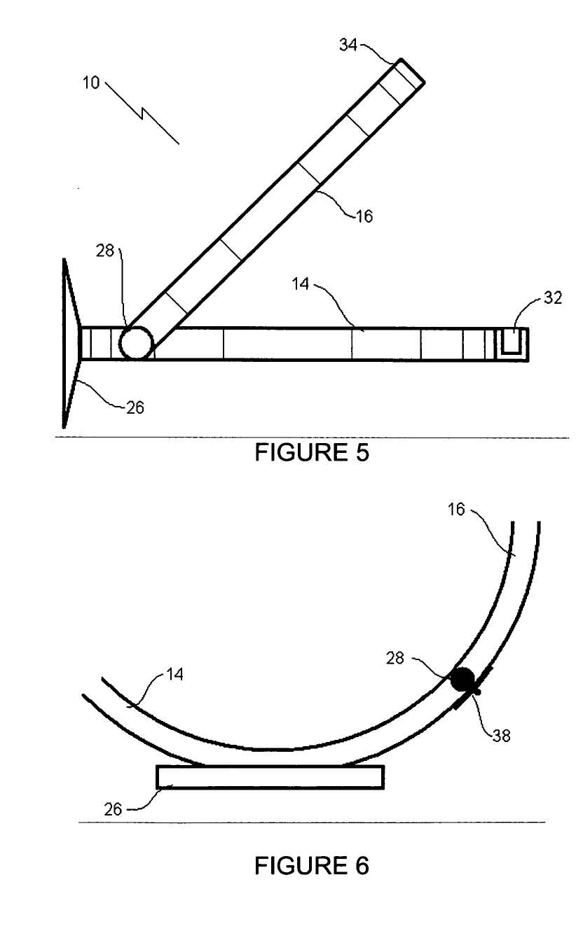

Variations from the preferred embodiment will now be discussed with reference to FIGS. 5 through 18.

Pivoting About a Horizontal Pivot Axis:

Referring to FIG. 4, hinge 28 may pivot about a substantially horizontal pivot axis. As shown, segment 16 is adapted to be lifted up, and first engagement 32 is adapted to receive second engagement 34 with an opening in the top such that segment 16 may be easily lifted.

Biasing to a Closed Position:

Referring to FIG. 6, segments 14 and 16 are biased toward the closed position by a spring 38, which may be replaced by a different resilient material. Spring 38 may be located on the outside of annular body 12, as shown, or on the inside. Alternatively, spring 38 may be included within hinge 28.

Use of a “Living Hinge”:

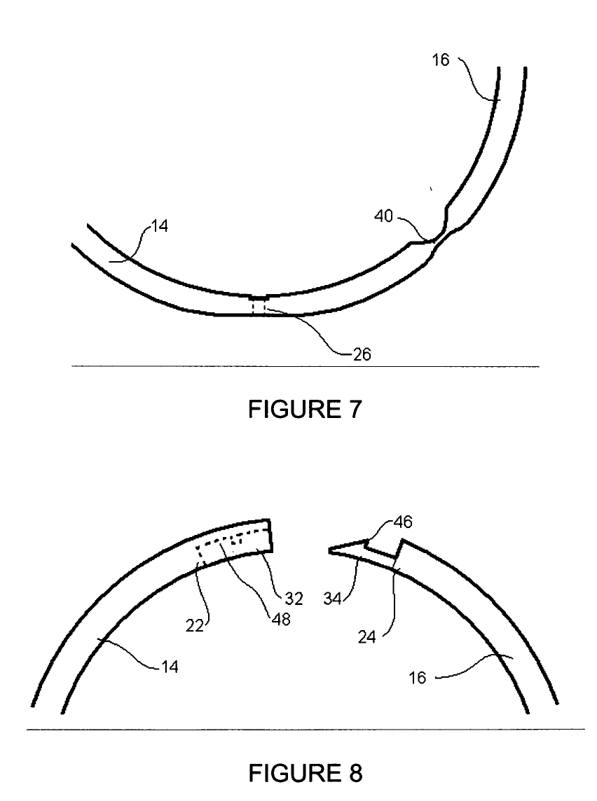

Referring now to FIG. 7, annular body 12 is made from polymer plastic and hinge 40 is a living hinge formed in the polymer plastic which functions based upon the flexure properties of the polymer plastic. A living hinge is a thin flexible web of material that joins two rigid bodies together.

Use of Alternative Engagements:

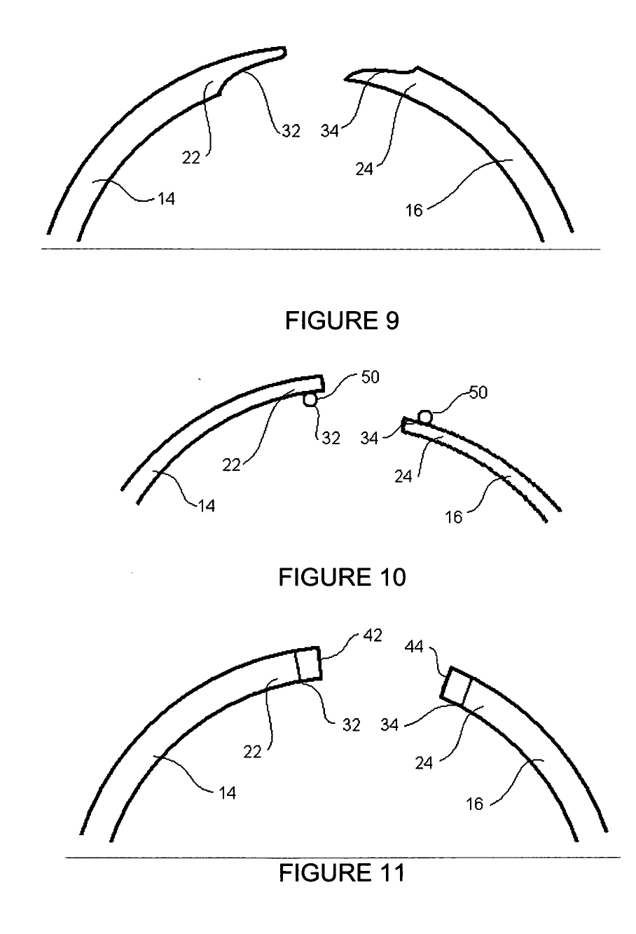

Referring to FIG. 8, first engagement 32 and second engagement 34 engage each other in a male/female fashion with a projection 46 engaging an indentation 48 such that second engagement 34 must be pushed back or first engagement 32 pulled forward to release the engagement. Referring to FIG. 9, first and second engagements 32 and 34 engage in an overlapping fashion, such that, when engaged, annular body 12 is continuous. There may or may not be a connection that resists disengagement. Referring to FIG. 10, first and second engagements 32 and 34 engage in an overlapping fashion, and have projections 50 that, when engaged, keep annular body 12 closed. Referring to FIG. 11, first and second engagements 32 and 34 have a magnetic engagement using magnetic components 42 and 44. Magnetic components 42 and 44 may have opposite polarized ends directed toward each other, or one may be a magnet and the other a conducting metal. FIG. 11 shows first and second engagements 32 and 34 meeting directly with no overlap or male/female connection. It will be understood that this arrangement is possible without magnetic components 42 and 44, which magnetic components 42 and 44 may be integrated into other means of engagement.

Alternative Mounting Means:

Referring to FIG. 5, mounting plate 26 is shown to be tapered on the sides, rather than rectangular as shown for example in FIG. 1. Referring to FIG. 7, mounting plate 26 is integral to annular body 12. In addition, instead of screws, an adhesive could be used to attach mounting plate 26 to vertical surface 27.

Referring to FIG. 19, mounting plate 26 includes a spring 51 such that body 12 is able to move when pressure is applied to either side. This prevents undue damage when curtain holder 10 is accidentally bumped.

Alternative Shapes of Body 12:

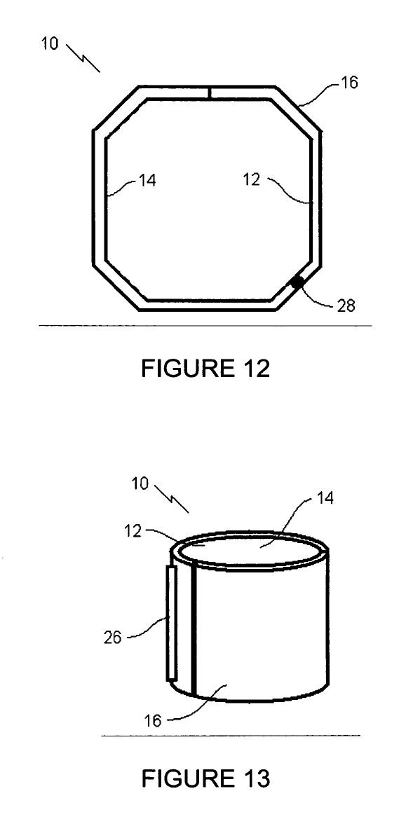

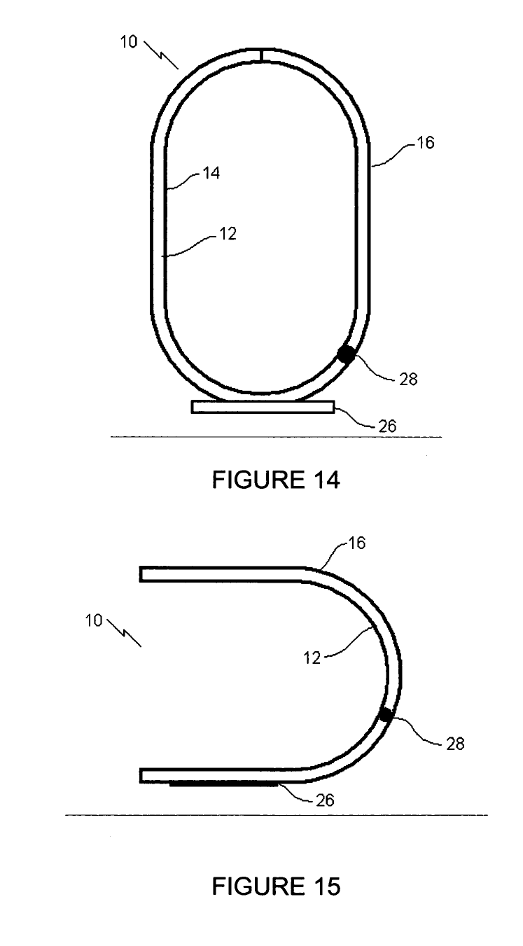

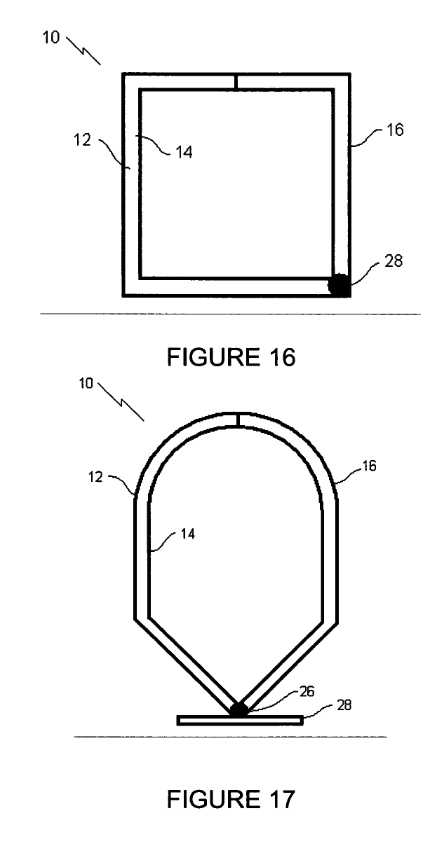

Referring now to FIGS. 12 through 16, annular body 12 need not be circular in shape. FIG. 12 shows body 12 as an octagon. FIG. 13 shows body 12 as a sleeve. FIG. 14 shows body 12 as an oval. FIG. 15 shows body 12 that is substantially annular but does not entirely enclose a curtain. For this embodiment, engagement means are unnecessary. FIG. 16 shows body as a square. FIGS. 17 and 18 show two other possible shapes for body 12.

Hinge to Permit Vertical Movement:

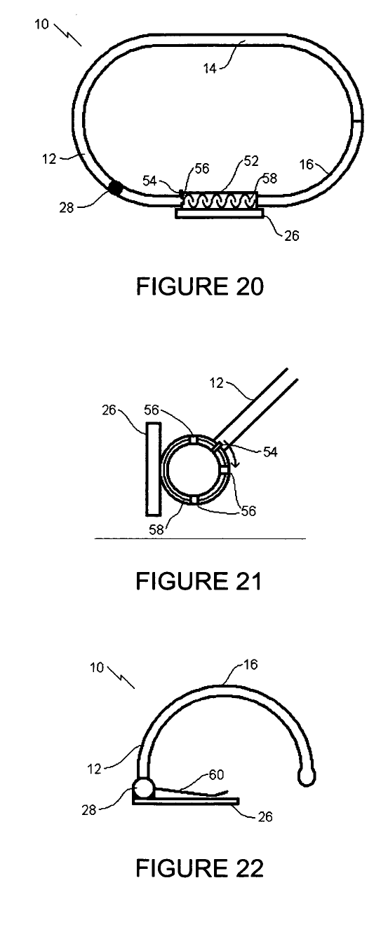

Referring to FIG. 20, body 12 may be adapted to rotate about a second hinge 52 such that body 12 can be moved between a vertical position and a horizontal position. The vertical position allows curtain holder 10 to be place out of the way when not holding a curtain, or to hold a curtain close to the wall. Body 12 includes a protrusion 54 that corresponds to a depression 56 in the side of hinge 52 to lock the position of body 12, while a spring 58 holds them in contact. Referring to FIG. 21, three depressions 56 are included to allow for three possible positions of body 12.

Multiple Connected Segments:

Although two connected segments have been illustrated for most embodiments, it will be appreciated that there could just as easily be three or more connected segments.

Curtain Holding Means:

Referring to FIG. 22, a curtain clip 60 may be included to hold the end of a curtain.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

This application claims priority from Canadian Application Serial No. 2,472,632 filed Jun. 10, 2004.

1. A curtain holder, comprising:
a body formed from at least two connected segments and defining a curtain confining enclosure, each of the segments having a connection end and a remote end;
means for mounting the body to a vertical surface; and
a hinge pivotally connecting the connection ends of the segments, such that the segments are pivotally movable between an open position in which the remote end of each of the segments are spaced apart to permit insertion of a curtain into the curtain confining enclosure and a closed position in which the remote end of the segments are closely spaced.

2. The curtain holder as defined in claim 1, wherein the hinge is independent of the mounting means.

3. The curtain holder as defined in claim 1, wherein the body is annular.

4. The curtain holder as defined in claim 1, wherein the segments are biased toward the closed position.

5. The curtain holder as defined in claim 4, wherein the segments are biased by a spring.

6. The curtain holder as defined in claim 1, wherein the hinge pivots about a substantially vertical pivot axis.

7. The curtain holder as defined in claim 1, wherein the hinge pivots about a substantially horizontal pivot axis.

8. The curtain holder as defined in claim 1, wherein the segments are unequal in size.

9. The curtain holder as defined in claim 1, wherein mounting means is a mounting plate.

10. The curtain holder as defined in claim 1, wherein the body is made from polymer plastic and the hinge is a living hinge formed in the polymer plastic which functions based upon the flexure properties of the polymer plastic.

12. The curtain holder as defined in claim 1, wherein the remote end of one the segments has a first engagement and the remote end of another of the segments has a second engagement, the first engagement and the second engagement engaging when the segments are in the closed position.

13. The curtain holder as defined in claim 12 wherein the first engagement and the second engagement have a magnetic engagement.

14. The curtain holder as defined in claim 12, wherein the first engagement and the second engagement have a mating engagement.

15. The curtain holder as defined in claim 12, wherein the first engagement and the second engagement have an overlapping engagement.

16. The curtain holder as defined in claim 12, wherein the remote end of one of the segments has a decorative member which conceals the first engagement and the second engagement when the segments are in the closed position.

17. The curtain holder as defined in claim 1, wherein the means for mounting the body to a vertical surface includes a spring.

18. The curtain holder as defined in claim 1, wherein the means for mounting the body to a vertical surface includes a hinge which is adapted to permit the body to be pivoted about a substantially horizontal pivot axis.

19. The curtain holder as defined in claim 1, wherein the means for mounting the body to a vertical surface including a clip adapted to clip onto and hold a curtain.

20. A curtain holder, comprising:
an annular body formed from two connected segments of unequal size and defining a curtain confining enclosure, each of the segments having a connection end and a remote end;
a mounting plate for mounting the annular body to a vertical surface;
a hinge offset from and independent of the mounting plate, the hinge pivotally connecting the connection ends of the segments for pivotal movement about a substantially vertical pivot axis, such that the segments are pivotally movable between an open position in which the remote end of each of the segments are spaced apart to permit insertion of a curtain into the curtain confining enclosure and a closed position in which the remote end of the segments are closely spaced; and
the remote end of one the segments has a first engagement and the remote end of another of the segments has a second engagement, the first engagement and the second engagement engaging when the segments are in the closed position.

21. The curtain holder as defined in claim 20, wherein the first engagement and the second engagement have a magnetic engagement.

22. The curtain holder as defined in claim 20, wherein the first engagement and the second engagement have a mating engagement.

23. The curtain holder as defined in claim 20, wherein the first engagement and the second engagement have an overlapping engagement.

24. The curtain holder as defined in claim 20, wherein the remote end of one of the segments has a decorative member which conceals the first engagement and the second engagement when the segments are in the closed position.
